(19) United States
(12) Patent Application Publication
(10) Pub. No.: US 2003/0202046 A1
(43) Pub. Date: Oct. 30, 2003

(54) Orifice plate having an edge area with an aperture

(76) Inventors: Smida Abdelli, Corvallis, OR (US); Mark C. Huth, Corvallis, OR (US); Rio Rivas, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/132,240

(22) Filed: Apr. 25, 2002

(51) Int. Cl. B41J 2/14

(52) U.S. Cl. 347/47

(57) ABSTRACT

The orifice plate has a central area with an orifice. The plate further has an edge area that surrounds the central area and is proximate to the edges of the orifice plate. The edge area has an aperture therein.

### BACKGROUND OF THE INVENTION

Generally, a fluid ejection device such as an ink jet printhead is used to emit ink drops in a precise manner to achieve an ink jet image. Typically, the fluid ejection device is located on a movable print carriage that moves over the surface of a print medium, ejecting the ink drops at a controlled rate.

Generally, a Hewlett-Packard printhead has an array of nozzles in an orifice plate that is attached to an ink barrier layer, which is attached to an active layer that implements ink firing heater resistors. Ink channels in the ink barrier include firing chambers disposed over associated ink firing resistors. The nozzles in the orifice plate are aligned with the associated firing chambers.

The active layer is a thin film substructure that typically includes a substrate layer such as silicon, on which are formed a plurality of thin layers that form thin film ink firing resistors, an apparatus for enabling the resistors, and interconnection to bonding pads that are provided for external electrical connections to the printer. A polymer material may be laminated as a dry film to the thin film substructure to form the ink barrier layer. Where the fluid ejection device has a slot feed design, ink may be fed from one or more ink reservoirs to a plurality of ink chambers using ink feed slots formed in the substrate. The orifice plate may not adhere properly to the ink barrier layer, resulting in the fluid ejection device having to be discarded. Therefore, an efficient and economical method of properly adhering the orifice plate to the barrier layer is desired.

### SUMMARY OF THE INVENTION

In general terms, an orifice plate according to an embodiment of the invention includes a central area having an orifice and an edge area surrounding the central area and proximate to edges of the orifice plate, wherein the edge area has an aperture therein.

Also, a fluid ejection device having the orifice plate, a method for manufacturing the orifice plate and a method of adhering the orifice plate of the fluid ejection device to a barrier layer of the fluid ejection device are set forth.

### BRIEF DESCRIPTION OF THE DRAWINGS

FIG. 1 is a perspective view of a pen having a fluid ejection device with an orifice plate coupled to the barrier layer with ultraviolet-curable glue according to an embodiment of the present invention.

FIG. 2 is an enlarged sectional view of the fluid ejection device taken along line 2-2 of FIG. 1.

FIGS. 3A and 3B are schematic drawings of a “dog bite” glue tab design near a corner of the orifice plate and a straight edge design along an edge of the orifice plate.

FIGS. 4A-14B are schematic drawings of alternate glue tab design embodiments along an edge area and at a corner area of the edge area according to the present invention.

FIG. 15 is a flow chart showing a first embodiment of steps of a method in accordance with the embodiments of the present invention.

FIG. 16 is a block diagram of one embodiment of a fluid ejection device, such as a printhead, with an orifice plate with window pane apertures arranged at predetermined positions in the orifice plate so that the orifice plate was coupled to the fluid ejection device die with ultraviolet-curable glue prior to lamination of the orifice plate to the barrier layer in accordance with the embodiments of the present invention.

### DETAILED DESCRIPTION OF THE PREFERRED EMBODIMENT

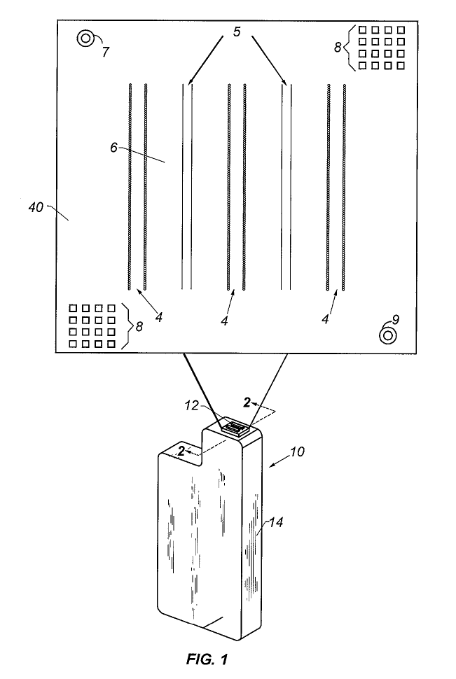

FIG. 1 shows a perspective view of a pen 10, such as, for example, an ink jet pen, having a pen body 14 (or cartridge) and a fluid ejection device 12 such as, for example, an ink jet printhead according to one embodiment of the present invention. The pen body 14 has a chamber for housing ink or fluid that is supplied to the fluid ejection device 12 for ejection. An electrical interconnect (not shown) connects the pen 10 to a printer controller to control printing.

The fluid ejection device has an orifice plate 40 with window pane apertures 8 arranged at predetermined positions therein. In a central area of the orifice plate 40 are rows of orifices 4. In the embodiment shown, six rows of about 300 orifices each are located in three sets of two. In between each set of orifices 4 are expansion joints 5 in areas 6. Surrounding the central area of the orifice plate 40 is an edge area. In the edge area shown in FIG. 1 are targets 7, 9 and window pane apertures 8 in a corner area of the edge area. In this embodiment, the apertures 8 are in opposing corners of the orifice plate, with the targets 7, 9 in the remaining corners.

In this embodiment, expansion joints are minute slots, approximately 5 to 10 microns in width, and have a length approximately the length of the orifices. The expansion joints are located between the orifices to provide stress relief. In the example shown, three rows of orifices are used, each for a different color. Between each row of orifices, in an approximately 50 micron width space, three 5 to 10 micron width expansion joints are used in this example. In this embodiment, targets 7, 9 are placed proximate to the edges of the orifice plate 40 in corner area for alignment purposes.

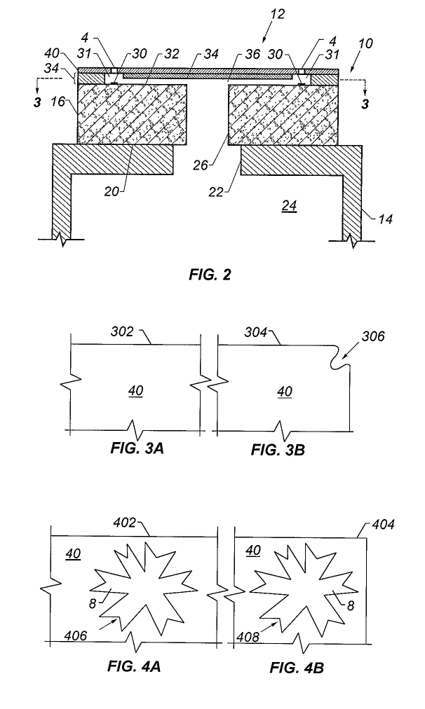

FIG. 2 is an enlarged sectional view of a fluid ejection device such as, for example, a printhead, taken along line 2-2 of FIG. 1. A rear surface 20 of a silicon substrate 16 is mounted, typically by lamination, to the pen body 14. A fluid outlet 22 in the pen body allows fluid, such as ink, to flow from a fluid chamber 24 of the pen body through a fluid channel 26 of the substrate 16. The substrate 16 provides a fluid channel 26. An active layer is formed over the upper surface 32 of the substrate. In this embodiment, the active layer includes a plurality of firing resistors (or heating elements) 30. A barrier layer 34 is formed over the active layer and upper surface of the substrate and defines a fluid manifold chamber 36 through which fluid flows from the fluid channel 26 to the resistors in the firing chamber 31. The orifice plate 40 is attached to the top of the barrier layer 34. Fluid orifices 4 in the orifice plate 40 are aligned with their respective firing chambers 31 and resistors 30. In a preferred embodiment, the orifice plate 40 is approximately 25 microns thick and the barrier layer 34 is approximately 14 microns thick. It should be noted that other thicknesses may be used, and that FIG. 2 is not drawn to scale. Orifice plate thickness typically varies from 13 to 50 microns, and the thickness of the barrier layer typically varies from 14 to 25 microns.

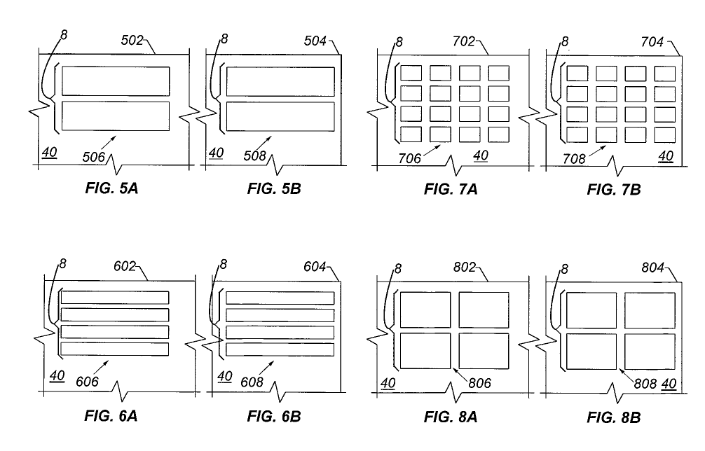

The embodiment shown in FIGS. 3A and 3B illustrates a “dog-bite” aperture in the corner area 304. The embodiment of FIG. 3A represents an edge area 302 that is between corner areas 304. In this embodiment, there are no apertures in the edge area 302. A “bite”-shaped aperture 306 is at approximately a 45 degree angle into the corner of the orifice plate in the corner area 304 in this embodiment. In one embodiment, the aperture is approximately 200 micron long by 200 micron wide.

When using the “dog bite” aperture 306 as shown in the embodiment of FIGS. 3A and 3B, often glue smears are encountered. Glue smears occur when uncovered UV glue spreads under the top plate 40 to nearby orifice 4. In some embodiments, alignment of the orifice plate over the substrate, as measured by the capability index, CPK, is generally not very accurate. The CPK is an alignment capability index that describes how well a system can meet two-sided specification limits.

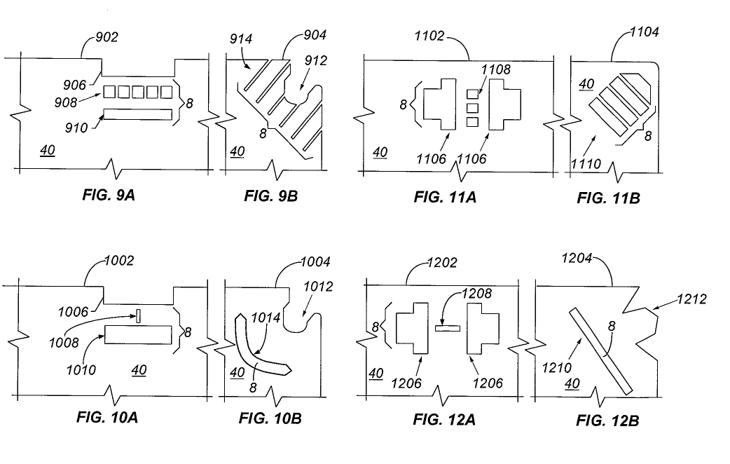

In FIGS. 4B-14B, not drawn to scale, the adhesive aperture 8 is formed in the corner areas of the orifice plate. The aperture 8 occupies, for example, an approximately 600×600 micron area in the corner area on the orifice plate 40. In FIGS. 4A-14A, the adhesive aperture 8 is formed proximate to an edge area in between corners or corner areas of the orifice plate 40.

FIGS. 4A and 4B show an embodiment with an adhesive aperture 8 in the shape of a star 406, 408 near an edge area 402 and near a corner area 404 of the orifice plate 40, respectively. In the embodiment shown, the stars 406, 408 have six inverted (or concave) points. A distance from a point of one projection of a star to a point of an opposing projection of the star generally ranges from 250 to 300 microns. In one embodiment, the stars are located approximately 50 microns from the edges of the orifice plate. In alternative embodiments, the number of points in the star are less than six, or greater than six. In yet another embodiment, the points are convex.

FIGS. 5A-5B show another embodiment of adhesive apertures 8. A set of two substantially parallel rectangular apertures 506, 508 is near both an edge area 502 (FIG. 5A) and a corner area 504 (FIG. 5B) of an orifice plate 40. As shown in this embodiment, the window pane apertures generally include a plurality of quadrilateral apertures, wherein sides of the quadrilaterals are perpendicular. Thus, the typical shape of the apertures is that of a square or a rectangle for this embodiment. The quadrilaterals may have perimeters in a range of two hundred microns to four hundred microns, and outermost quadrilaterals are generally located approximately 50 microns from an edge in this embodiment. In this embodiment, the quadrilaterals are spaced from about 25 to 50 microns apart from one another. In alternative embodiments, a plurality of squares, rectangles or a combination of squares and rectangles may be used to form the window pane apertures. In this embodiment, the window pane typically has sides ranging in size from approximately 400 to 600 microns in length. In other alternative embodiments, for example, a square or rectangular window pane set of apertures has sixteen to twenty quadrilateral apertures.

FIGS. 6A-6B show another embodiment of adhesive apertures 8. This embodiment has a set of four substantially parallel rectangular apertures 606, 608 near an edge area 602 (FIG. 6A) and near a corner area 604 (FIG. 6B) of the orifice plate 40, respectively. In this embodiment, the four apertures in FIGS. 6A-6B are generally approximately 50 to 100 microns in width, about 400 to 500 microns in length, and about 25 to 50 microns apart from one another. In this embodiment, the outer edges of the apertures near the edges of the orifice plate are located about 25 to 50 microns from the edges of the plate.

FIGS. 7A-7B show another embodiment of adhesive apertures 8. This embodiment has a design with a set of sixteen square window pane apertures 706, 708 in a four by four pattern, each set near an edge area 702 (FIG. 7A) and near a corner area 704 (FIG. 7B) of the orifice plate 40, respectively. In this embodiment, each square aperture ranges from about 75 to 100 microns on a side and are placed approximately 25 to 50 microns apart. Outer edges of outer squares near the edges of the orifice plate are about 25 to 50 microns from the orifice edge in this embodiment.

In one embodiment, the four apertures used in the FIGS. 6A-6B design perform better than the two apertures in the FIGS. 5A-5B design with respect to alignment, but are outperformed by the FIGS. 7A-7B design.

FIGS. 8A-8B show another embodiment of adhesive apertures 8. This embodiment has an edge pattern design near an edge area 802 (FIG. 8A) and a proximate corner design near a corner area 804 (FIG. 8B) that include four square apertures 806, 808 each. The square apertures 806, 808 overlie an area approximately equivalent to an area covered by the four by four pattern of sixteen square window pane apertures of FIGS. 7A-7B. In this particular embodiment, the square apertures range from about 150 to 250 microns on a side, and are located approximately 25 to 50 microns apart. Square apertures near the orifice edge area (FIG. 8A) are approximately 25 to 50 microns from the orifice edge in this embodiment.

FIGS. 9A and 9B show another embodiment of adhesive apertures 8. An edge area 902 of the embodiment of FIG. 9A includes a rectangular shaped trench 906, five aligned square apertures 908 located proximate to the trench 906, and a rectangular aperture 910 located adjacent to the square aperture 908 on a side of the apertures 908 opposite the trench 906. The trench 906 extends inward on the orifice plate 40 approximately 100 microns in this embodiment. The five square apertures in this embodiment are approximately 100 microns in length on a side, and are located approximately 25 to 50 microns from the outer edge and each other. The apertures 908 are approximately 25 to 50 microns from the approximately 100 by 600 micron rectangular aperture in this embodiment.

The corner area 904 of FIG. 9B in this embodiment of the aperture 8 includes a “dog bite” aperture 912 and a series of six slits 914. The aperture 912 of this embodiment is similar to the dog bit aperture described in FIG. 3B. These slits 914 are diagonally positioned in the corner area. In the embodiment illustrated in FIG. 9B, the six narrow slits 914 extend substantially in parallel from the corner area towards a center of the orifice plate. The slits 914 are angled at approximately 45 degree, and form about a 400 to 500 micron square area of the corner area 904. The substantially parallel slits 914 are each approximately 2 to 3 microns wide and have a length of about 25 to 35 microns.

FIGS. 10A and 10B show another embodiment of adhesive apertures 8. This embodiment of FIG. 10A has an edge area 1002 with a rectangular trench 1006 similar to trench 906. In this embodiment, a small rectangular aperture 1008 is positioned along the trench 1006, and a rectangular aperture 1010 is positioned adjacent the aperture 1008 opposite the trench 1006. The aperture 1010 is substantially the same length as the trench 1006 in this embodiment, extending approximately 100 microns into the interior of the orifice plate 40. The rectangular aperture 1008 may range in size from about 25 to 35 microns in width, and about 75 to 100 microns in length in this embodiment. This aperture 1008 has the shorter sides substantially parallel to the lengths of the trench 1006 and the aperture 1010. This aperture 1008 is located approximately 25 to 50 microns from the edge area 1002 of the orifice plate 40. This rectangular aperture 1010 ranges from about 100 to 125 in width, and about 500 to 600 microns in length. This aperture 1008 is located approximately 25 to 50 microns from the small rectangular aperture 1008.

The embodiment of FIG. 10B illustrates a corner area 1004 having another embodiment of an adhesive aperture 8. In this embodiment the corner area 1004 includes a “dog bite” aperture 1012 (similar to that of FIG. 3) at the corner area and a “boomerang” shaped aperture 1014 proximate to the aperture 1012. The aperture 1014 has a width of approximately 80 to 120 microns, has a side length of approximately 400 to 500 microns, and is positioned to curve around the dog bite aperture 1012. A base of the “boomerang” aperture 1014 is at a lower left hand corner of an approximately 600 by 600 micron square area of the corner area 1004, in this embodiment.

FIGS. 11A and 11B show another embodiment of adhesive apertures 8. This embodiment has an edge area 1102 as shown in FIG. 11A. Along the edge area 1102 are two T-shaped apertures 1106, each having an upper section and a lower section. The T-shaped apertures 1106 lie on their sides such that upper sections of the respective apertures are facing towards each other. In this embodiment, in between the apertures 1106 are a row of three apertures 1108. Each of the apertures 1108 are approximately 75 to 100 microns on a side and are substantially square, but may be rectangular. These T-shaped apertures 1106 are approximately 400 to 500 microns in length along the upper section, and are approximately 75 to 100 microns in depth along the upper section. In the lower sections of these apertures 1106, the width is about 50 to 75 microns, and approximately 75 to 100 microns in length. In this embodiment, the total length of the apertures 1106 and 1108 along the edge area 1102 is about 300 to 350 microns.

In the embodiment of the corner area 1104 shown in FIG. 11B are four apertures 1110. Three of the apertures 1110 are substantially rectangular in shape, and are aligned adjacent to and substantially parallel to each other in this embodiment. Each of these apertures is about 100 by 400 microns in size. Longitudinal sides of these adjacent apertures are spaced about 25 to 50 microns apart. The fourth of the apertures 1110 is substantially trapezoidal in shape in this embodiment. The trapezoidal aperture is positioned closest to the corner area 1104 of the plate. In this embodiment, the trapezoidal aperture is rotated at an angle of 45 degrees, such that sides of the trapezoid are substantially parallel with sides of the orifice plate. In this embodiment, the remaining three of the apertures 1110 are adjacent a base of the trapezoid, the longitudinal side of the first one of the substantially rectangular apertures being spaced about 25 to 50 microns from the base of the substantially trapezoidal aperture. The four apertures 1110 are arranged in an approximately 600 by 600 micron square area located at the corner area 1104 of the orifice plate 40 in this embodiment. The trapezoidal aperture is placed approximately 25 to 50 microns from the edge of the orifice plate 40 in this embodiment.

FIGS. 12A and 12B show another embodiment of adhesive apertures 8. This embodiment has an edge area 1202 as shown in FIG. 12A, and a corner area 1204 as shown in FIG. 12B. Along the edge area 1202 are two T-shaped apertures 1206, each having an upper section and a lower section. The apertures 1206 lie sideways such that upper sections of the respective apertures are facing towards each other. The T-shaped apertures 1206 of FIG. 12A are approximately 20% larger than the T-shaped apertures 1106 of FIG. 11A. In this embodiment, in between the apertures 1206 is a substantially rectangular shaped aperture 1208. The rectangular aperture 1208 is approximately 50 to 75 microns by 200 to 250 microns and lies with the longer side being substantially parallel to the edge area 1202 of the plate.

In the corner area 1204 of the embodiment shown in FIG. 12B are substantially rectangular aperture 1210 and crescent-shaped aperture 1212 in the corner of the orifice plate. In this embodiment, the aperture 1210 is approximately 50 to 75 microns by 500 to 600 microns. In one embodiment, the aperture 1210 lies at an angle to edges that form the corner of the orifice plate such that by extending the edges and the longer side of the aperture 1210 until they meet, a triangle shape is substantially defined in the corner area. In this embodiment, the angle formed by the longitudinal side of the aperture 1210 and the edges of the plate is about 45 degrees. The aperture 1210 is spaced from the aperture 1212 and within an approximately 600×600 micron square area at the corner in this embodiment.

The crescent aperture 1212 is in the corner of the orifice plate such that two arms of the crescent shape extend into the corner area from along the edges thereof. In one embodiment, the crescent wrench aperture 1208 is a combination of two adjacent dog bite apertures and is an approximately 200 by 200 micron square located at the corner of the orifice plate 40.

FIGS. 13A and 13B show another embodiment of adhesive apertures 8. This embodiment has an edge area 1302 as shown in FIG. 13A, and a corner area 1304 as shown in FIG. 13B. In this embodiment, the adhesive aperture 8 is in the shape of a star 1306, 1308, respectively. In the embodiment shown, the star apertures 1306, 1308 each have six inverted (or concave) points. A distance from one point on the star to an opposing point is approximately 350 to 400 microns in this embodiment. Thus, the star apertures 1306, 1308 are slightly larger than the stars 406, 408 of FIGS. 4A-4B. In alternative embodiments, the number of points may be less than six or greater than six. In yet another embodiment, the points are convex.

FIGS. 14A and 14B show another embodiment of adhesive apertures 8. This embodiment has an edge area 1402 as shown in FIG. 14A, and a corner area 1404 as shown in FIG. 14B. The embodiment of FIG. 14A shows two T-shaped apertures 1406 with apertures 1408 there between in the edge area 1402. Apertures 1406 and 1408 are similar to those apertures 1106 and 1108 of FIG. 11A. However, in this embodiment, the T-shaped apertures 1406 and the apertures 1408 are approximately 20% larger than the apertures 1106, 1108 of FIG. 11A. In this embodiment, the three square apertures 1408, are centered between the T-shaped apertures 1406 at approximately 25 to 50 microns distance from the T-shaped apertures.

In the corner area of the embodiment shown in FIG. 14B are three apertures 1410. These three apertures 1410 include one polygon aperture and two substantially rectangular apertures. The polygon aperture is located closest to the corner of the orifice plate. Longitudinal sides of the apertures 1410 are aligned adjacent to and substantially parallel to each other in this embodiment. Each of these apertures is about 120 by 450 microns in size. Longitudinal sides of these adjacent apertures are spaced about 25 to 50 microns apart. The polygon aperture is substantially rectangular in shape in this embodiment, with two adjacent corners cut. The cut corners of the polygon aperture are the corners closest to the corner of the orifice plate, and furthest from the other two apertures 1410. In this embodiment, the apertures are rotated at an angle of 45 degrees, extending from the corner of the orifice plate towards a center of the orifice plate. The three apertures 1410 are arranged in an approximately 600 by 600 micron square area located at the corner area 1404 of the orifice plate 40 in this embodiment. The polygon aperture is placed approximately 25 to 50 microns from the edge of the orifice plate 40 in this embodiment. Thus, the FIGS. 14A-B design is similar to the FIGS. 11A-11B design, but each of the three apertures in FIGS. 14A-14B are larger than each of the four apertures in FIGS. 11A-11B.

It should be noted that each of the aperture 8 designs may be used interchangeably with each other. For example, in one embodiment, the corner area aperture design 4B is used with the edge aperture design 5A.

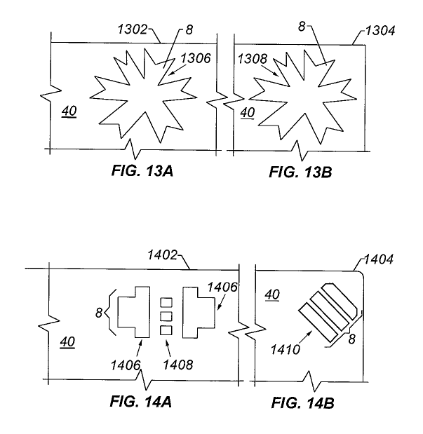

As shown in FIG. 15, a method of one embodiment of the present invention for coupling the orifice plate to the barrier layer includes the following. Initially, in a first embodiment, an aperture is formed 1502 proximate to each of two opposing corners. A predetermined amount of glue is applied 1504 to the barrier layer in this embodiment. The orifice plate is then aligned and applied 1506 to the glue disposed on the barrier layer. The glue is then cured 1508 in this embodiment. In an alternative embodiment, the orifice plate 40 is applied with sufficient pressure to force at least part of the glue through the window pane apertures 8 at each corner of the orifice plate 40.

In a particular embodiment, the method includes curing 1508 the glue by exposing the glue to ultraviolet light for a predetermined time. Typically, the ultraviolet-curable glue utilized is UV 307 glue, a one-part ultraviolet light-curing adhesive that cures via long wavelength ultraviolet radiation in a range of approximately 365 nanometers plus or minus 20%. For example, a typical predetermined time for curing may be approximately 0.5 second.

Typically, the glue is applied to the barrier layer directly beneath where the apertures 8 in the orifice plate are to be positioned. Thus, the glue may be applied under a corner area of the orifice plate or near edge areas, or both.

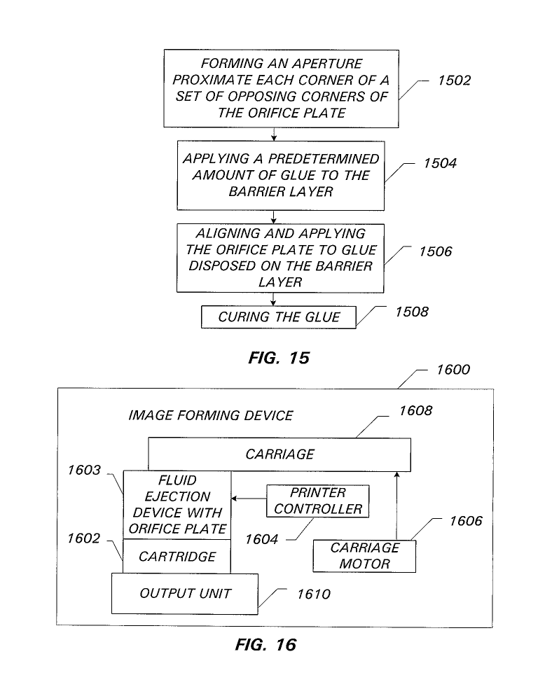

FIG. 16 is one embodiment of a block diagram of an image forming device 1600, such as, for example, an ink jet printer, having a fluid ejection cartridge 1602 that has a fluid ejection device with orifice plate 1603. The device 1603 has an orifice plate with apertures used, together with glue, to adhere the orifice plate to a barrier layer. The fluid ejection cartridge 1602 may be a replaceable printer component. A carriage motor 1606, coupled to a carriage 1608, is typically used to move the fluid ejection cartridge 1602 for image formation in accordance with a predetermined scheme. A printer controller 1604 is coupled to the fluid ejection device with orifice plate 1603 and is used to activate the resistors in the device in accordance with a printing scheme. Alternatively, a heating element may be used in place of a resistor. Typically, the fluid ejection device with orifice plate 1603 prints the desired output onto media in an output unit 1610 that is generally arranged to feed media proximate to the fluid ejection device to facilitate the printing procedure.

The embodiments of the present invention provide a method for coupling an orifice plate to a barrier layer. Using this method aids in preventing uncured glue from traveling under the orifice plate to resistors. When glue smears and travels to the resistors, the result in some embodiments is an inoperable ejection device. In some embodiments, an approximately 0.6% yield loss of printheads is experienced due to glue smears. In other embodiments having apertures in the orifice plate, a 0.0% yield loss is incurred due to glue smears. Use of window pane apertures in the corner areas of the orifice place allows for a greater margin of error in the amount of glue application as well as providing more flexibility in the location of the application of the glue, in some embodiments. In additional embodiments, because the glue is allowed to protrude into, as well as through, the apertures in the orifice plate, more ultraviolet light reaches the glue, resulting in more complete curing. In these embodiments, because the tolerances for glue drop placement and for glue drop size are increased, glue smear is reduced and throughput gain is experienced in production of the fluid ejection device such as, for example, ink jet printheads. In one production line, a twelve to twenty percent throughput gain was experienced.

Thus, methods, a fluid ejection device and an image forming device have been described according to the embodiments of the present invention. Many modifications and variations may be made to the techniques and structures described and illustrated herein without departing from the spirit and scope of the invention. Accordingly, it should be understood that the methods, the fluid ejection device and the image forming device described herein are illustrative only and are not limiting upon the scope of the invention.

What is claimed is:

1. An orifice plate comprising:
a central area having an orifice; and
an edge area surrounding the central area and proximate to edges of the orifice plate, the edge area having an aperture therein.

2. The orifice plate of claim 1 wherein the edge area includes corner areas of the orifice plate, wherein the aperture is proximate one of the corner areas of the orifice plate.

3. The orifice plate of claim 2 further comprising two apertures, wherein the apertures are in opposing corner areas of the orifice plate.

4. The orifice plate of claim 1 wherein the aperture is at least one of a quadrilateral aperture, a star aperture, a boomerang aperture, a crescent aperture, an elliptical aperture, and a T-shaped aperture.

5. The orifice plate of claim 4 wherein the edge area further has a series of substantially parallel slits formed from edges of the orifice plate.

6. The orifice plate of claim 1 wherein there are a plurality of quadrilateral apertures in the edge area, wherein each quadrilateral has a perimeter in a range of two hundred microns to four hundred microns.

7. The orifice plate of claim 6 wherein at least one of the plurality of quadrilateral apertures has a different dimension as compared to other apertures.

8. The orifice plate of claim 1 wherein the orifice plate includes a “dog bite” in a corner area thereof.

9. A fluid ejection device comprising:
a substrate; and
an orifice plate having opposing corner areas with an aperture therein, wherein the orifice plate adheres to the substrate.

10. The device of claim 9 further comprising an active layer formed over the substrate, and a barrier layer formed over the active layer, wherein the active layer has a heating element and the barrier layer has a chamber associated with the heating element, wherein an orifice in the orifice plate is positioned over the chamber and heating element when the orifice plate adheres to the barrier layer.

11. The device of claim 10 further comprising glue deposited over the barrier layer.

12. A fluid ejection device comprising:
an active layer formed over a substrate, wherein the active layer has a heating element;
a barrier layer formed over the active layer, wherein the barrier layer has a chamber associated with the heating element;
an orifice plate formed over the barrier layer, the orifice plate having a central area with an orifice, and an edge area surrounding the central area and proximate to edges of the orifice plate, the edge area having an aperture, wherein the orifice is positioned over the chamber and heating element; and
glue adhering the orifice plate and the barrier layer,
wherein the glue is exposed in the aperture of the orifice plate.

13. The fluid ejection device of claim 12 wherein the glue is ultraviolet-curable glue.

14. A method of manufacturing an orifice plate, comprising the steps of:
forming an orifice in a central area of the orifice plate; and
forming an aperture in an edge area surrounding the central area and proximate to edges of the orifice plate.

15. A method of adhering an orifice plate of a fluid ejection device to a barrier layer of the fluid ejection device, the method comprising:
applying glue to the barrier layer;
positioning and pressing the orifice plate over the glue on the barrier layer,
wherein the orifice plate has a central area having an orifice and an edge area surrounding the central area and proximate to edges of the orifice plate, the edge area having an aperture therein.

16. The method of claim 15 wherein the glue is exposed in the aperture of the orifice plate.

17. The method of claim 15 wherein the glue is ultraviolet-curable, and the method further includes curing the glue with ultraviolet light.

18. The method of claim 17 wherein the ultraviolet-curable glue is UV 307 glue.

19. The method of claim 15 wherein the orifice plate is pressed onto the barrier layer with sufficient pressure to force at least part of the glue through the aperture.
